(19) United States
(12) Patent Application Publication
(10) Pub. No.: US 2013/0218570 A1
(43) Pub. Date: Aug. 22, 2013

(54) APPARATUS AND METHOD FOR CORRECTING SPEECH, AND NON-TRANSITORY COMPUTER READABLE MEDIUM THEREOF

(71) Applicants: Kazunori IMOTO, Kanagawa-ken (JP); Makoto HIROHATA, Tokyo (JP)

(72) Inventors: Kazunori IMOTO, Kanagawa-ken (JP); Makoto HIROHATA, Tokyo (JP)

(73) Assignee: KABUSHIKI KAISHA TOSHIBA, Tokyo (JP)

(21) Appl. No.: 13/591,660

(22) Filed: Aug. 22, 2012

(30) Foreign Application Priority Data
Feb. 17, 2012 (JP) 2012-033387

(51) Int. Cl. G10L 21/00

(52) U.S. Cl. 704/270; 704/E21.001

(57) ABSTRACT

According to one embodiment, in an apparatus for correcting a speech corresponding to a moving image, a separation unit separates at least one audio component from each audio frame of the speech. An estimation unit estimates a scene including a plurality of image frames related in the moving image, based on at least one of a feature of each image frame of the moving image and a feature of the each audio frame. An analysis unit acquires attribute information of the plurality of image frames by analyzing the each image frame. A correction unit determines a correction method of the audio component corresponding to the plurality of image frames, based on the attribute information, and corrects the audio component by the correction method.

### CROSS-REFERENCE TO RELATED APPLICATION

This application is based upon and claims the benefit of priority from Japanese Patent Application No. 2012-033387, filed on Feb. 17, 2012; the entire contents of which are incorporated herein by reference.

### FIELD

Embodiments described herein relate generally to an apparatus and a method for correcting speech, and a non-transitory computer readable medium thereof.

### BACKGROUND

As to a speech reproduced with a moving image, by analyzing the moving image, an apparatus for correcting the speech based on the analysis result exists.

In conventional technique of the audio correction apparatus, by detecting the number of persons appeared in the moving image, the speech is emphasized or a directivity thereof is controlled based on the number of persons.

In another conventional technique of the audio correction apparatus, based on a position of an object appeared in the moving image or a movement status of a camera imaging the object, the speech is outputted so that a voice (or a sound) of the object is uttered from a position of the object.

However, in this audio correction apparatus, the speech is independently corrected for each frame of the moving image. Accordingly, in a series of scenes, as to a frame not including the object (a person, an animal, an automobile, and so on) actually uttering, the speech thereof is not corrected.

As a result, in the series of scenes, when a frame including the object actually uttering and another frame not including the object, the speech hard for a viewer to hear is outputted.

### BRIEF DESCRIPTION OF THE DRAWINGS

FIG. 1 is a block diagram of an audio correction apparatus 1 according to a first embodiment.

FIG. 2 is a flow chart of processing of the audio correction apparatus 1.

FIG. 3 is one example of a moving image suitable for the audio correction apparatus 1 to process.

FIG. 4 is a flow chart of processing of a separation unit 20 in FIG. 1.

FIG. 5 is a flow chart of processing of an estimation unit 30 in FIG. 1.

FIG. 6 is a schematic diagram to explain similar shots.

FIG. 7 is a flow chart of processing of an analysis unit 40 in FIG. 1.

FIG. 8 is a flow chart of processing of a correction unit 50 in FIG. 1.

FIG. 9 is a block diagram of an audio correction apparatus 2 according to a second embodiment.

FIG. 10 is one example of a moving image suitable for the audio correction apparatus 2 to process.

FIG. 11 is a flow chart of processing of an estimation unit 31 in FIG. 9.

FIG. 12 is a flow chart of processing of a correction unit 51 in FIG. 9.

FIG. 13 is one example of a moving image suitable for an audio correction apparatus 3 to process.

FIG. 14 is a block diagram of the audio correction apparatus 3 according to a third embodiment.

FIG. 15 is a flow chart of processing of a separation unit 22 in FIG. 14.

FIG. 16 is a flow chart of processing of an estimation unit 32 in FIG. 14.

FIG. 17 is a flow chart of processing of an analysis unit 52 in FIG. 14.

FIG. 18 is a flow chart of processing of a correction unit 52 in FIG. 14.

FIG. 19 is a block diagram of an audio correction apparatus 4 according to a fourth embodiment.

FIG. 20 is a flow chart of processing of a correction unit 53 in FIG. 19.

### DETAILED DESCRIPTION

According to one embodiment, an apparatus that corrects a speech corresponding to a moving image includes a separation unit, an estimation unit, an analysis unit, and a correction unit. The separation unit is configured to separate at least one audio component from each audio frame of the speech. The estimation unit is configured to estimate a scene including a plurality of image frames related in the moving image, based on at least one of a feature of each image frame of the moving image and a feature of the each speech frame. The analysis unit is configured to acquire attribute information of the plurality of image frames by analyzing the each image frame. The correction unit is configured to determine a correction method of the audio component corresponding to the plurality of image frames, based on the attribute information, and correct the audio component by the correction method.

Various embodiments will be described hereinafter with reference to the accompanying drawings.

### The First Embodiment

An audio correction apparatus 1 of the first embodiment is, for example, usable for a device outputting a moving image with a speech, such as a television, a personal computer (PC), a tablet type PC, a smart phone, and so on.

The audio correction apparatus 1 corrects a speech corresponding to a moving image. The speech is one to be reproduced in correspondence with the moving image. This speech includes at least one audio component. The audio component is a sound uttered by respective objects as a sound source, such as a person's utterance, an animal's utterance, an environmental sound, and so on.

As to image frames belonging to the same scene in the moving image, by using a correction method common to each of the image frames, the audio correction apparatus corrects the speech.

As a result, the speech corresponding to the moving image is corrected to a speech easy for a viewer to hear. Moreover, the moving image and the speech are synchronized by time information.

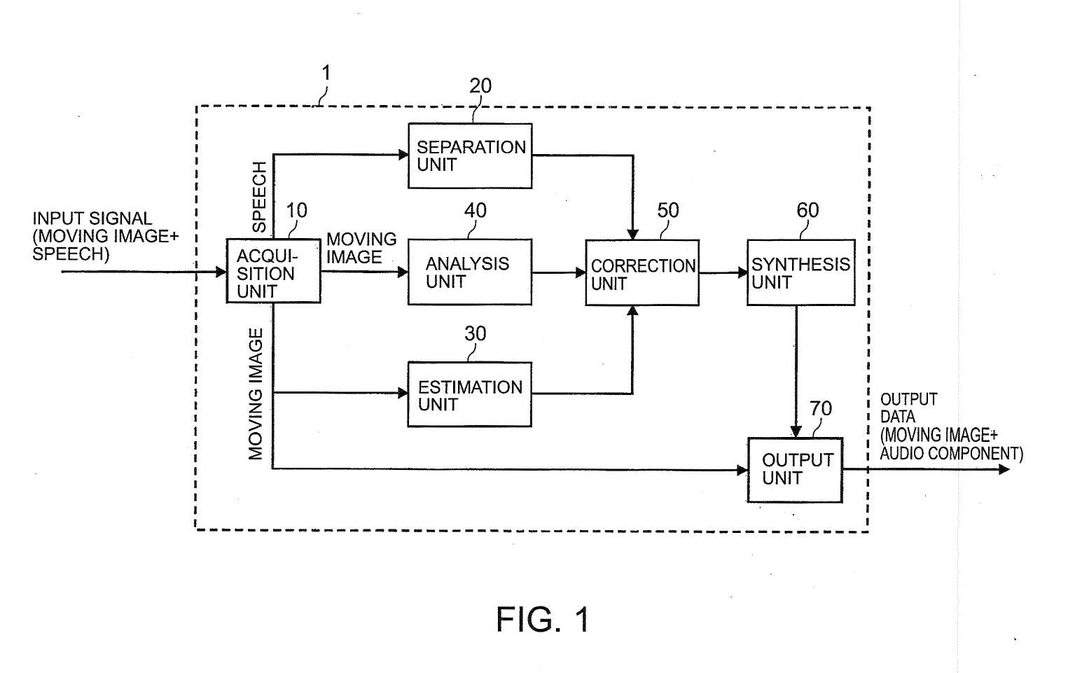

FIG. 1 is a block diagram of the audio correction apparatus 1. The audio correction apparatus 1 includes an acquisition unit 10, a separation unit 20, an estimation unit 30, an analysis unit 40, a correction unit 50, a synthesis unit 60, and an output unit 70.

The acquisition unit 10 acquires an input signal. The input signal includes a moving image and a speech corresponding thereto. For example, the acquisition unit 10 may acquire the input signal from a broadcasting wave. Alternatively, the acquisition unit 10 may acquire contents stored in a hard disk recorder (HDD) as the input signal. From the input signal acquired, the acquisition unit 10 supplies a speech to the separation unit 20. Furthermore, from the input signal acquired, the acquisition unit 10 supplies a moving image to the estimation unit 30, the analysis unit 40 and the output unit 70.

The separation unit 20 analyzes the speech supplied, and separates at least one audio component from the speech. For example, when the speech includes utterances of a plurality of persons and an environmental sound, the separation unit 20 analyzes the speech, and separates the utterances and the environmental sound from the speech. Detail processing thereof is explained afterwards.

The estimation unit 30 estimates a scene in the moving image supplied, based on a feature of each image frame included in the moving image. The scene includes a series of image frames mutually related. For example, the estimation unit 30 detects a cut boundary in the moving image, based on a similarity of the feature of each image frame.

Here, a set of image frames between a cut boundary P and a previous cut boundary Q is called “a shot”. The estimation unit 30 estimates the scene, based on the similarity of the feature among shots.

The analysis unit 40 analyzes the moving image, and acquires attribute information as an attribute of image frames included in the scene estimated. For example, the attribute information includes the number of an object (a person, an animal, an automobile, and so on) or a position thereof in the image frame, and motion information of camera work such as a zoom and a pan in the scene. Furthermore, the attribute information is not limited thereto. If the object is a person, information related to a position and a motion of the person's face (such as a mouth) may be included.

Based on the attribute information, the correction unit 50 sets a method for correcting an audio component corresponding each image frame in the scene, and corrects at least one of each audio component separated. This method is explained afterwards.

The synthesis unit 60 synthesizes each audio component corrected. The output unit 70 unifies audio components (synthesized) with the moving image (supplied from the acquisition unit 10) as an output signal, and outputs the output signal.

The acquisition unit 10, the separation unit 20, the estimation unit 30, the analysis unit 40, the correction unit 50, the synthesis unit 60 and the output unit 70, may be realized by a central processing unit (CPU) and a memory utilized thereby. Thus far, component of the audio correction apparatus 1 is explained.

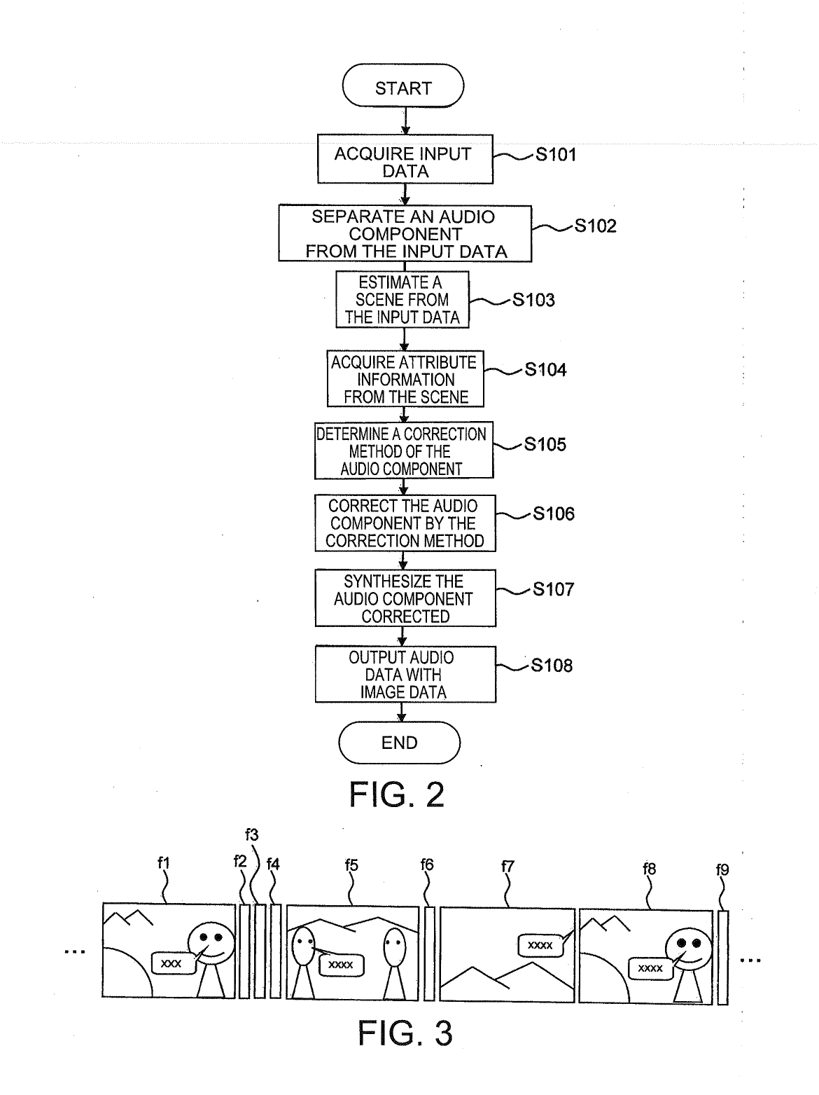

FIG. 2 is a flow chart of processing of the audio correction apparatus 1. The acquisition unit 10 acquires an input signal (S101). The separation unit 20 analyzes a speech supplied, and separates at least one audio component from the speech (S102). The estimation unit 30 estimates a scene in a moving image (supplied), based on a feature of each image frame in the moving image (S103).

The analysis unit 40 analyzes the moving image, and acquires attribute information of an object appeared in the scene (S104). Based on the attribute information, the correction unit 50 determines a method for correcting an audio component corresponding to each image frame in the scene (S105).

For each image frame in the scene, the correction unit 50 corrects at least one of each audio component by the correction method (S106). The synthesis unit 60 synthesizes each audio component corrected (S107). The output unit 70 unifies audio components (synthesized) with the moving image (supplied from the acquisition unit 10), outputs the output signal (S108), and processing is completed. Thus far, processing of the audio correction apparatus 1 is explained.

Hereinafter, the separation unit 20, the estimation unit 30, the analysis unit 40 and the correction unit 50, are explained in detail.

FIG. 3 is one example of a moving image suitable for the audio correction apparatus 1 to process. As shown in FIG. 3, in the first embodiment, suppose that a moving image including a scene in which characters talk in drama. This scene includes image frames f1˜f9. An image frame f7 is an insert shot as an image of a circumference scenery inserted in a conversation of characters. During the insert shot, the conversation of characters continues.

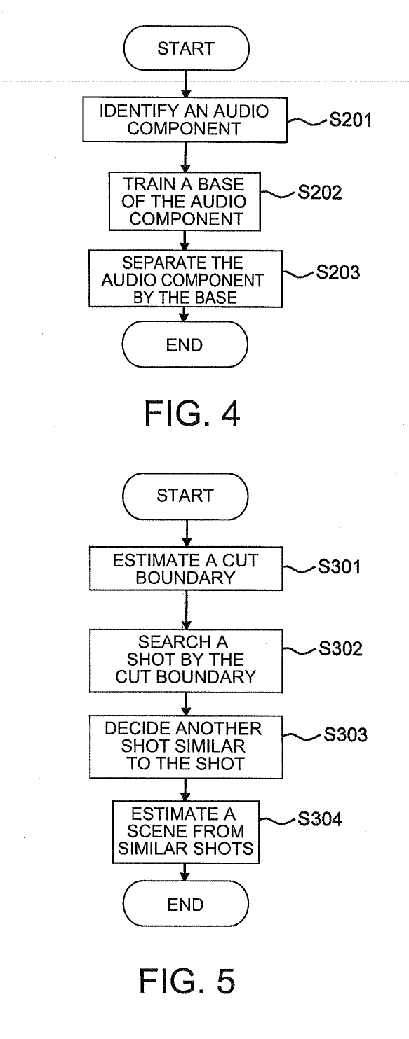

FIG. 4 is a flow chart of processing of the separation unit 20. The separation unit 20 converts a speech (supplied from the acquisition unit 10) to a feature of each speech frame (segmented from the speech at a predetermined interval), and identifies an audio component included in each speech frame (S201).

In order to identify the audio component, the separation unit 20 may preserve a speech model such as an utterance, music, noise, and combination thereof. Moreover, as a method for calculating the feature and an algorithm to identify the audio component, conventional technique of speech recognition area may be used.

The separation unit 20 identifies three types of audio components, i.e., (1) utterance, (2) environmental sound except for utterance, (3) mixture sound of utterance and environmental sound. Furthermore, the separation unit 20 trains a base of the environmental sound from a segment in which the environmental sound except for the utterance is detected, and trains a base of the utterance from a segment of other sounds (the utterance or the mixture sound) (S202).

From each audio frame, the separation unit 20 separates an audio component of the utterance and an audio component of the environmental sound (S203). For example, the separation unit 20 may separate the utterance and an environmental noise by a known separation method using nonnegative matrix factorization.

If this separation method is used, the separation unit 20 resolves a spectrogram of the environmental sound signal into a basic matrix and a coefficient matrix. The spectrogram is a set of spectral acquired by analyzing a frequency of the speech signal.

By using the basic matrix of the environmental sound, the separation unit 20 estimates a basic matrix representing the utterance (except for the environmental sound) and a coefficient matrix corresponding to the basic matrix from the spectrogram.

Accordingly, when the audio component is identified, the separation unit 20 trains a base of the environmental sound from a segment decided as the environmental sound, and estimates a basic matrix and a coefficient matrix of the utterance from a segment decided as the utterance or the mixture sound (the utterance and the environmental sound).

After the basic matrix and the coefficient matrix of the utterance, and the basic matrix and the coefficient matrix of the environmental sound, are estimated, the separation unit 20 calculates a spectrogram of the utterance as a product of the basic matrix and the coefficient matrix of the utterance. Furthermore, the separation unit 20 calculates a spectrogram of the environmental sound as a product of the basic matrix and the coefficient matrix of the environmental sound.

By subjecting spectrograms of the utterance and the environmental sound to inverse Fourier transform, the separation unit 20 separates each audio component from the speech. Moreover, a method for separating each audio component is not limited to above-mentioned method. Furthermore, the audio component is not limited to the utterance and the environmental sound. Thus far, processing of the separation unit 20 is explained.

FIG. 5 is a flow chart of processing of the estimation unit 30. As to the moving image supplied from the acquisition unit 10, the estimation unit 30 calculates a similarity of feature between an image frame to be presently processed and a previous image frame, and estimates a cut boundary in the moving image (S301). The estimation unit 30 may estimate the cut boundary by using conventional technique of image recognition area. Then, the estimation unit 30 determines a shot as a set of image frames included between a cut boundary P and a previous cut boundary Q (S302).

As to a shot R to be presently processed, the estimation unit 30 decides whether another shot (in the past time) has a feature similar to the shot R (S303). Here, another shot having the similar feature is called “a similar shot”.

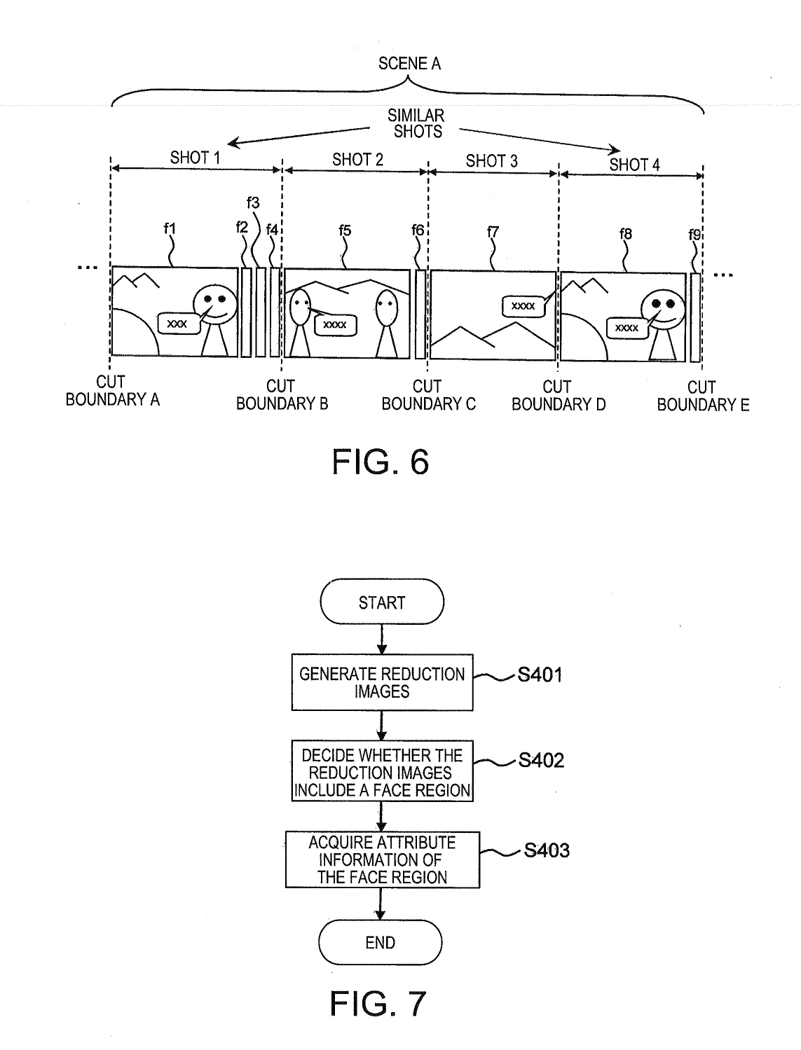

FIG. 6 is a schematic diagram to explain the similar shot. By processing of S301˜S302, from the moving image shown in FIG. 3, cut boundaries A˜E and shots 1˜4 shown in FIG. 6 are estimated. Briefly, a shot 1 is estimated from cut boundaries A and B. A shot 2 is estimated from cut boundaries B and C. A shot 3 is estimated from cut boundaries C and D. A shot 4 is estimated from cut boundaries D and E.

The shot 1 includes image frames f1˜f4. The shot 2 includes image frames f5˜f6. The shot 3 includes an image frame f7. The shot 4 includes image frames f8˜f9. Moreover, image frames f2˜f4 are decided to have a feature similar to an image frame f1. Accordingly, the image frames f2˜f4 are omitted in FIGS. 3 and 6. An image frame f6 is decided to have a feature similar to an image frame f5. Accordingly, the image frame f6 is omitted in FIGS. 3 and 6. An image frame f9 is decided to have a feature similar to an image frame f8. Accordingly, the image frame f9 is omitted in FIGS. 3 and 6.

Here, an image frame at the head position of each shot is regarded as a typical frame. Briefly, the image frame f1 is a typical frame of the shot 1, the image frame f5 is a typical frame of the shot 2, the image frame f7 is a typical frame of the shot 3, the image frame f8 is a typical frame of the shot 4.

For example, the estimation unit 30 may estimate similar shots by comparing a similarity of a feature between two typical frames of two shots. In this case, as to two typical frames of two shots, the estimation unit 30 divides each typical frame into blocks, and calculates an accumulative difference by accumulating a difference of pixel value between corresponding blocks of two typical frames. When the accumulative difference is smaller than a predetermined threshold, the estimation unit 30 decides the two shots are similar. In this example, as shown in FIG. 6, two typical frames f1 and f8 are decided to be similar. Accordingly, two shots 1 and 4 are estimated as similar shots.

When similar shots are estimated, the estimation unit 30 assigns ID to each similar shot, and preserves similar shot information such as a duration of each similar shot, an appearance frequency and an appearance pattern of similar shots. In this example, the estimation unit 30 assigns the same ID (For example, ID “A”) to two shots 1 and 4.

The appearance frequency of similar shots represents the number of similar shots to the number of image frames included in the moving image. The appearance pattern of similar shots represents timing when the similar shots appear. In this example, the appearance pattern of similar shots is “similar shot A (shot 1), -, -, similar shot A (shot 4)”. Here, “-” represents non-similar shot A.

When similar shots are detected, the estimation unit 30 estimates a scene by using similar shot information. Briefly, the estimation unit 30 estimates a series of shots as the same scene (S304). For example, within the (predetermined) number of continuous shots (For example, four shots), if the number of similar shots appeared in the continuous shots is larger than or equal to a fixed number (For example, two), the estimation unit 30 estimates the continuous shots as the same scene (scene A in FIG. 6). In this example, similar shot A (shot 1, shot 4) appears two times in four shots 1˜4. Accordingly, the estimation unit 30 estimates four shots 1˜4 as the same scene.

The estimation unit 30 supplies cut boundary information as a boundary of each scene to the correction unit 50, and completes processing thereof. Thus far, processing of the estimation unit 30 is explained.

FIG. 7 is a flow chart of processing of the analysis unit 30. From an image frame to be presently processed in the moving image (supplied from the acquisition unit 10), the analysis unit 40 generates at least one reduction image of which sizes are mutually different (S401).

By generating reduction images of which sizes are mutually different, face regions having various sizes included in the image frame can be compared with templates having the same size, and detected.

The analysis unit 40 sets a search region into each reduction image, calculates a feature from the search region, and decides whether the search region includes a face region by comparing the feature with a template (S402). Here, by shifting the search region along up and down direction and along right and left direction on each reduction image, the analysis unit 40 can detect a face region from all regions of the reduction image.

Moreover, by previously storing a facial model and comparing with the facial model a plurality of times, the analysis unit 40 may decide whether the search region includes a face region. For example, by using Adaboost as one of adaptive boosting method, the analysis unit 40 may decide whether the search region includes the face region. Adaboost is a method by combining a plurality of weak learners. By training a weak learner of second phase so that erroneous detected image included in a weak learner of first phase is separated, rapidity and high discrimination ability can be realized.

Furthermore, by targeting a face region (of person) passed with decision of a plurality of weak learners, the analysis unit 40 may execute face clustering processing, i.e., a face region appeared in the moving image is identified, and the face region is clustered for each person. As the face clustering processing, a method for clustering a feature (extracted from the face region) on a feature space by Mean-Shift method may be utilized.

When a face region is detected from the image frame, the analysis unit 40 acquires attribute information such as the number of face regions and a position thereof included in the image frame (S403), and completes the processing. Furthermore, at 5403, the analysis unit 40 may detect a motion of the face region or a camera work among continuous image frames, and include them into the attribute information.

Moreover, in this example, the face region of a person is set to a detection target. However, various objects such as an animal or an automobile may be set to the detection target. In this case, the analysis unit 40 may previously store a model to detect an object as the detection target, and decide whether the object (corresponding to the model) is included in the image frame. Thus, processing of the analysis unit 40 is explained.

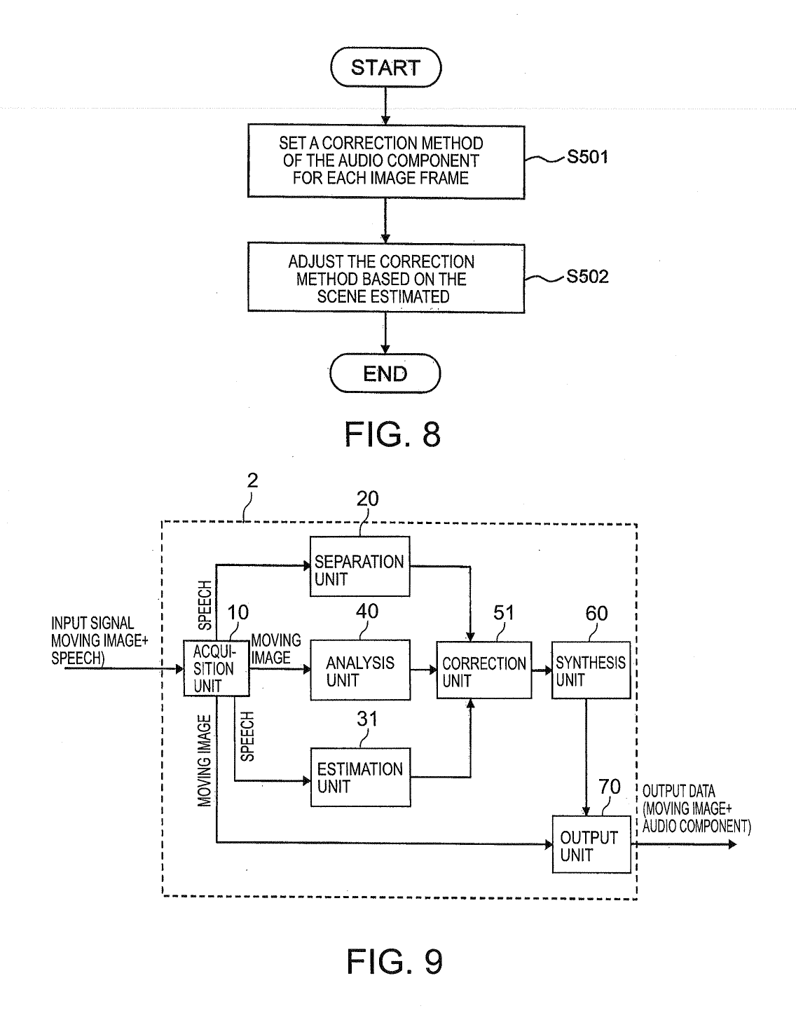

FIG. 8 is a flow chart of processing of the correction unit 50. Based on attribute information acquired by the analysis unit 40, the correction unit 50 sets a correction method of an audio component for each image frame of the moving image (S501). In this example, the attribute information represents the number of face regions of persons included in the image frame.

For example, the correction unit 50 decides for each image frame, (1) whether the number of face regions is “0”, (2) whether the number of face regions is larger than or equal to “1”. When the number of face regions is “0” (in case of (1)), the correction unit 50 sets the correction method to maintain an audio component corresponding to the image frame. When the number of face regions is larger than or equal to “1” (in case of (2)), the correction unit 50 sets the correction method to emphasize (For example, enlarge a volume) an audio component corresponding to the image frame.

As to a scene estimated by the estimation unit 30, the correction unit 50 adjusts the correction method set to each image frame (S502). Briefly, as to the scene estimated by the estimation unit 30, the correction unit 50 whether to change the correction method of each image frame.

For example, in FIG. 6, the correction unit 50 decides that face regions are detected from shots 1, 2 and 4. Furthermore, the correction unit 50 decides that a face region is not detected from a shot 3. Moreover, when face regions are detected from the greater part of image frames included in one shot, the correction unit 50 may decide that the face regions are detected from the one shot.

At S501, a face region is not detected from a shot 3. Accordingly, a correction method different from shots 1, 2 and 4 is set to the shot 3. Briefly, a correction method of above mentioned (2) is set to an audio component corresponding to shots 1, 2 and 4, and a correction method of above mentioned (1) is set to an audio component corresponding to the shot 3.

At S502, the correction unit 50 adjusts the correction method so that the same correction method is set to audio components corresponding to shots included in one scene. Here, among correction methods set to shots included in one scene, the correction unit 50 selects one correction method corresponding to the largest number of shots included in the one scene, and adjusts another correction method corresponding to shots except for the largest number of shots included in the one scene.

In FIG. 6, among shots included in a scene A, a correction method (2) is already set to three shots 1, 2 and 4, and a correction method (1) is already set to a shot 3.

Accordingly, the correction unit 50 changes the correction method (1) of an audio component of the shot 3 to the correction method (2). Briefly, the correction unit 50 adjusts the correction method so that the same correction method is set to audio components of all shots included in a scene A.

Furthermore, the correction unit 50 may correct each audio component so that utterance from each person is output from a position of each person based on a facial position of each person. In this case, the attribute information includes the facial position of each person. Thus far, processing of the correction unit 50 is explained.

In the first embodiment, as to shots included in the same scene (estimated by the estimation unit 30), each audio component of the shots is corrected by the same correction method. Accordingly, as to a shot in which a person does not appear (such as the shot 3 in FIG. 6), stable correction without fluctuation can be performed.

Furthermore, in the first embodiment, if a person detected from the image is failed, the stable correction without fluctuation can be performed.

### The Second Embodiment

In an audio correction apparatus 2 of the second embodiment, a scene boundary is estimated from not a moving image but a speech, and an audio component is corrected to suppress the speech in a scene having an image frame in which a person uttering does not appear. These two features are different from the first embodiment. A flow chart of processing of the audio correction apparatus 2 is same as the flow chart (FIG. 2) of the audio correction apparatus 1.

FIG. 9 is a block diagram of the audio correction apparatus 2. In the audio correction apparatus 2 compared with the audio correction apparatus 1, the estimation unit 30 is replaced with an estimation unit 31, and the correction unit 50 is replaced with a correction unit 51. Furthermore, the acquisition unit 10 supplies a speech to the estimation unit 31.

Based on a feature of each audio frame of the speech, the estimation unit 31 estimates a scene in a moving image. For example, from a similarity of the feature among each audio frame, the estimation unit 31 detects a time at which the feature largely changes as a scene boundary in the moving image.

Based on attribute information acquired by the analysis unit 40, the correction unit 51 sets a correction component of an audio component corresponding to each image frame in the scene, and corrects at least one audio component separated by the separation unit 20. The estimation unit 31 and the correction unit 51 may be realized by a CPU and a memory used thereby.

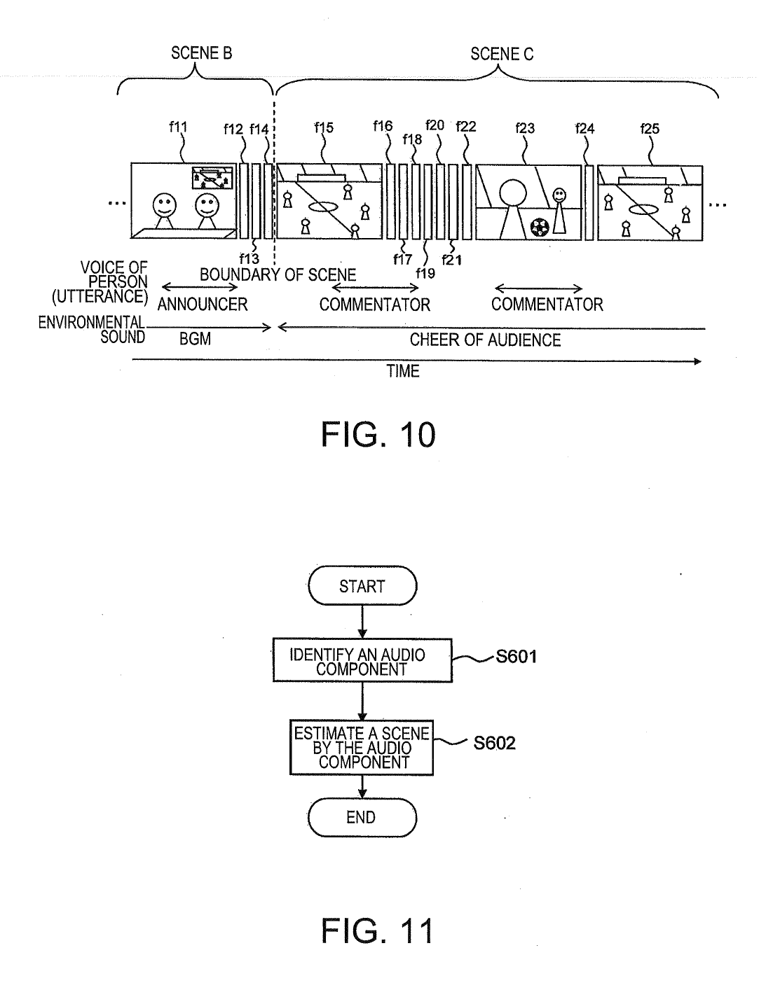

FIG. 10 is one example of a moving image suitable for the audio correction apparatus 2 to process. As shown in FIG. 10, the moving image includes a scene that an announcer and a commentator are imaged and another scene that a sport game is imaged in a sport broadcast such as soccer.

Briefly, in FIG. 10, image frames f11˜f14 are images in which an announcer and a commentator are photographed. Image frames f15˜f22 and f25 are images in which a stadium during the game is photographed by zoom-out angle. Image frames f23˜f24 are images in which players during the game are photographed by zoom-in angle. Here, image frames f12˜f14 are similar to image frame f11, and explanation thereof is omitted. Image frames f16˜f22 are similar to image frame f15, and explanation thereof is omitted. Image frames f24 is similar to image frame f23, and explanation thereof is omitted.

Furthermore, speech corresponding to image frames f11˜f14 includes BGM, and speech corresponding to image frames f15˜f25 includes a cheer of audience continuously. Furthermore, at a partial time in the speech corresponding to image frames f11˜f14, the announcer is uttering. At a partial time in the speech corresponding to image frames f15˜f25, the commentator is uttering.

In this way, among the moving image, image frames in which a person uttering does not appear are often included. In the second embodiment, while a speech environment of the stadium during the game is maintained, the speech is corrected so that utterances of announcer and commentator are suppressed.

FIG. 11 is a flow chart of processing of the estimation unit 31. Based on a feature of each audio frame segmented from a speech (supplied by the acquisition unit 10) at a predetermined interval, the estimation unit 31 identifies an audio component included in the audio frame (S601). In the second embodiment, the estimation unit 31 identifies seven types of audio components, i.e., “speech”, “music”, “cheer”, “noise”, “speech+music”, “speech+cheer”, and “speech+noise”. For example, the estimation unit 31 may previously store speech models to identify seven types of audio components, and identify each audio component by comparing each audio frame with the speech models.

The estimation unit 31 compares audio components between two adjacent audio frames, and estimates a scene (S602). For example, the estimation unit 31 may estimate a scene by setting a scene boundary between two audio frames of which audio components are different.

Moreover, in order to raise accuracy to identify the audio component, the estimation unit 31 may perform estimation processing by targeting a component of the environmental sound (separated by the separation unit 30).

As a result, in FIG. 10, a scene boundary is estimated to be between images frames f14 and f15, and two scenes B and C are estimated. Thus far, processing of the estimation unit 31 is explained.

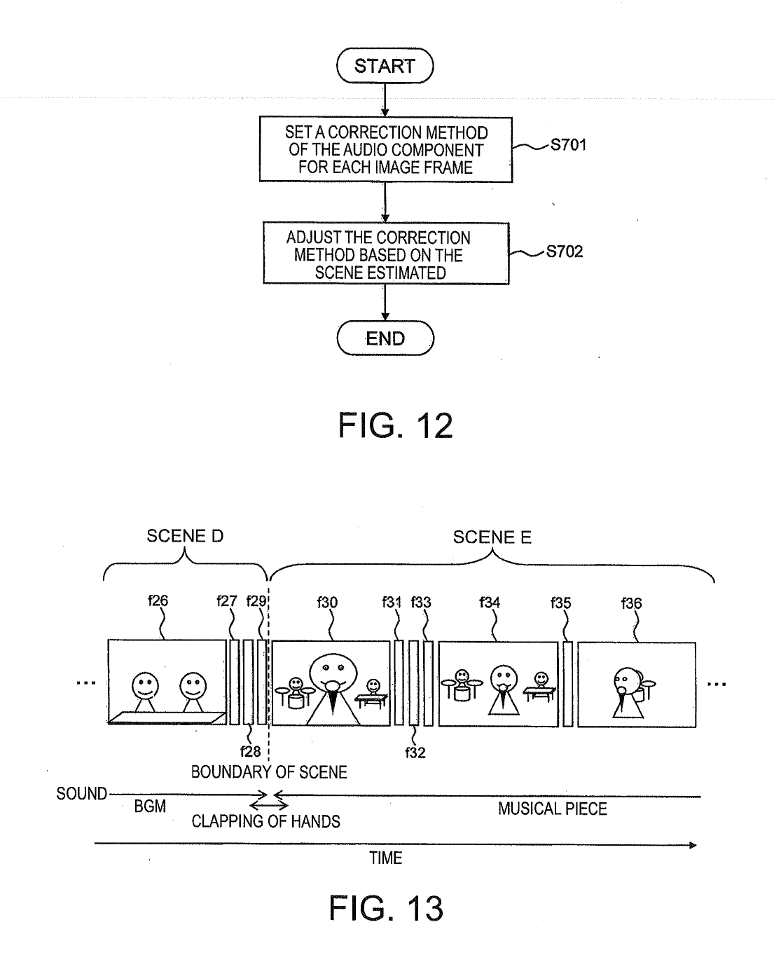

FIG. 12 is a flow chart of processing of the correction unit 51. Based on attribute information acquired by the analysis unit 40, the correction unit 51 sets a correction method of an audio component corresponding to each image frame in the moving image (S701). In this example, the attribute information represents the number of face regions of persons included in each image frame.

For example, the correction unit 51 decides for each image frame, (1) whether the number of face regions is “0”, (2) whether the number of face regions is larger than or equal to “1”. When the number of face regions is “0” (in case of (1)) the correction unit 51 sets the correction method to suppress an audio component corresponding to the image frame. When the number of face regions is larger than or equal to “1” (in case of (2)), the correction unit 50 sets the correction method to maintain an audio component corresponding to the image frame.

In FIG. 10, the analysis unit 40 detects face regions from image frames f11˜f14 in which announcer and commentator appear and image frames f23˜f24 in which players during the game are photographed by zoom-up.

As to a scene estimated by the estimation unit 31, the correction unit 51 adjusts a correction method of each image frame included therein (S702). Briefly, as to scenes B and C estimated by the estimation unit 31, the correction unit 51 decides whether to change the correction method of each image frame.

For example, in the moving image of FIG. 10, the correction unit 51 decides that face regions of persons are detected from image frames f11˜f14 of scene B and image frames f23˜f24 of scene C. Furthermore, the correction unit 51 decides that face regions of persons are not detected from image frames f15˜f22 and f25 of scene C.

At S701, the correction method of above-mentioned (2) is set to audio components corresponding to image frames f11˜f14 of scene B and image frames f23˜f24 of scene C. Furthermore, the correction method of above-mentioned (1) is set to audio components corresponding to image frames f15˜f22 and f25 of scene C.

At S702, as to audio components corresponding to image frames included in one scene, the correction unit 51 adjusts the correction method so that the same correction method is set to the image frames. Here, among correction methods set to image frames included in one scene, the correction unit 51 selects one correction method corresponding to the largest number of image frames included in the one scene, and adjusts another correction method corresponding to image frames except for the largest number of image frames included in the one scene.

In FIG. 10, among image frames included in the scene C, the correction method (2) is already set to two image frames f23˜f24, and the correction method (1) is already set to fourteen image frames f15˜f22 and f25.

Accordingly, the correction unit 51 changes the correction method (2) of audio components of the image components f23˜f24 to the correction method (1). Briefly, the correction unit 51 adjusts the correction method so that the same correction method is set to audio components of all image frames included in the scene C.

As to audio components corresponding to image frames included in the scene B, the correction method (2) is already set thereto.

Furthermore, the correction unit 51 may correct each audio component so that utterance from each person is output from a position of each person based on a facial position of each person. In this case, the attribute information includes the facial position of each person. Thus far, processing of the correction unit 51 is explained.

In the second embodiment, as to audio components corresponding to image frames estimated as the same scene, the same correction method is applied. Accordingly, even if a person actually uttering is different from persons appearing on the scene (such as image frames f23˜f24 of scene C in FIG. 10), stable correction without fluctuation can be performed.

### The Third Embodiment

FIG. 13 is one example of a moving image suitable for an audio correction apparatus 3 of the third embodiment to process. As shown in FIG. 13, image frames f26˜f29 represent a talk scene before playing a musical piece, and image frames f30˜f36 represent a scene of the musical piece being played.

Furthermore, image frames f34˜f35 are further zoom-out than image frames f30˜f33. An image frame f36 is photographed by a camera further moving to the right side than image frames f34˜f35.

As to image frames f26˜f29 as a talk scene, BGM is inserted. As to image frames as a musical piece scene, a play sound by musical instruments and a singing voice by a singer are inserted. Furthermore, as to a boundary between the talk scene and the musical piece scene (image frames f29˜f30), a clapping sound of hands is inserted.

In this way, even if a musical piece is inserted into the speech, the moving image often includes image frames that a singer does not appear while playing BGM and image frames that the singer synchronously appears. In the second embodiment, audio components corresponding to a scene of the musical piece synchronized with the moving image are corrected to match with camera work.

Following features of the audio correction apparatus 3 of the third embodiment are different from the first and second embodiments. First, a target to be detected from image frames is not a person but a musical instrument. Second, an audio component corresponding to each musical instrument is separated from the speech. Third, a scene boundary is estimated from a specific sound co-occurred at the scene boundary. Fourth, from a position of the singer or the musical instrument appeared in the moving image, the audio component is corrected so that a viewer can hear sounds occurred from the position.

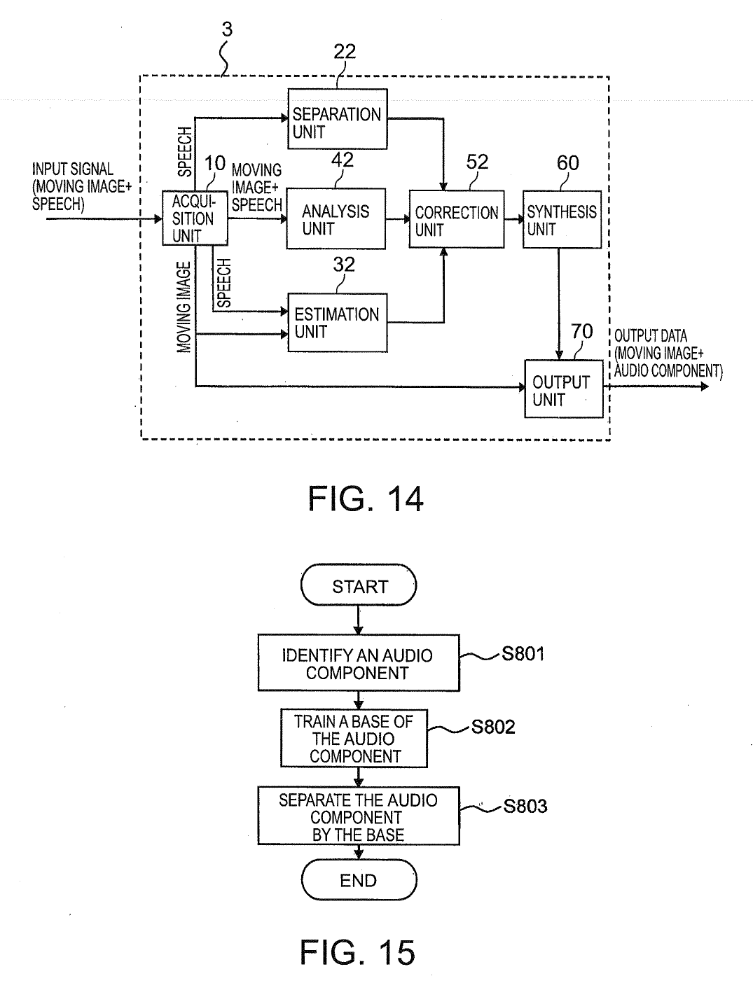

FIG. 14 is a block diagram of the audio correction apparatus 3. In the audio correction apparatus 3 compared with the audio correction apparatus 1, the separation unit 20 is replaced with a separation unit 22, the estimation unit 30 is replaced with an estimation unit 32, the analysis unit 40 is replaced with an analysis unit 42, and the correction unit 50 is replaced with a correction unit 52.

The separation unit 22 analyzes a speech supplied from the acquisition unit 10, and separates at least one audio component from the speech. Moreover, the separation unit 22 may store the audio component into a memory (not shown in FIG. 14). From the speech on which a plurality of audio components (such as a singing voice and a musical instrumental sound) is superimposed, the separation unit 22 separates each audio component. Detail processing thereof is explained afterwards.

The estimation unit 32 analyzes a speech or a moving image (supplied from the acquisition unit 10), and estimates a boundary of a scene (including a plurality of image frames) by detecting a specific sound or a specific image co-occurred at the boundary. Detail processing is explained afterwards.

The analysis unit 42 analyzes the speech or the moving image (supplied from the acquisition unit 10), and acquires attribute information. For example, the attribute information includes the number of persons (appeared in image frames) and each position thereof, and the number of musical instruments (appeared in image frames) and each position thereof. Image frames to be processed by the analysis unit 42 can be generated by decoding the moving image corresponding to the speech.

Based on the attribute information acquired by the analysis unit 42, the correction unit 52 sets a correction method of an audio component corresponding to each image frame in the scene, and corrects the audio component of at least one musical instrument separated by the separation unit 22. The separation unit 22, the estimation unit 32, the analysis unit 42 and the correction unit 52, may be realized by a CPU and a memory used thereby.

FIG. 15 is a flow chart of processing of the separation unit 22. Based on a feature of each audio frame segmented from a speech (supplied by the acquisition unit 10) at a predetermined interval, the separation unit 22 decides an audio component included in each audio frame (S801). In the third embodiment, three types of audio components, i.e., “singing voice”, “musical instrumental sound” and “singing voice+musical instrumental sound”, are set as a learning class, and a base of a musical instrument is trained from an audio frame from which the musical instrumental sound is detected. From an audio frame including the singing voice or an audio frame including the singing voice and the musical instrumental sound, a base and a coefficient of the singing voice are estimated by using the base of the musical instrument (S802).

After estimating a basic matrix and a coefficient matrix of the singing voice and the musical instrument respectively, the separation unit 22 approximates a spectrogram of the singing voice by a product of the basic matrix and the coefficient matrix of the singing voice, and approximates a spectrogram of the musical instrument by a product of the basic matrix and the coefficient matrix of the musical instrument. By subjecting these spectrograms to inverse Fourier transform, the separation unit 22 separates the singing voice and each musical instrumental sound from the speech (S803). Moreover, a method for separating the audio component is not limited to above-mentioned method. Furthermore, the audio component is not limited to the singing voice and the musical instrumental sound. Thus far, processing of the separation unit 22 is explained.

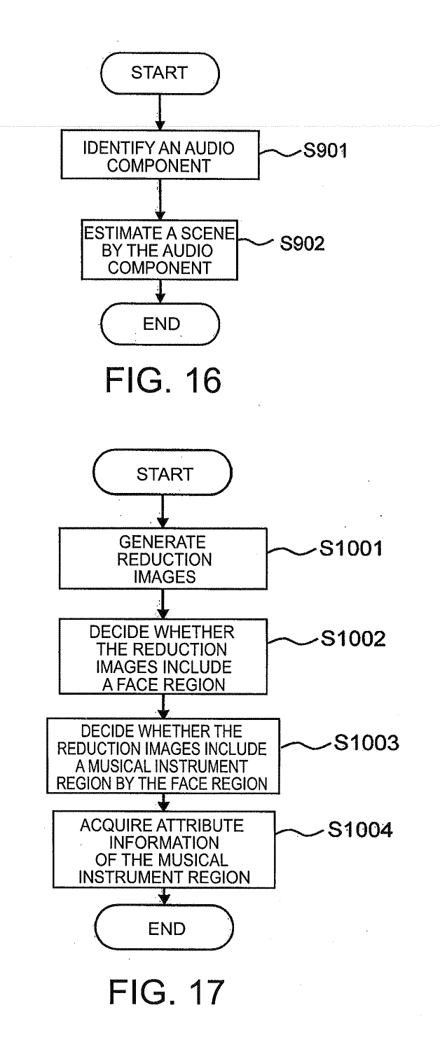

FIG. 16 is a flow chart of processing of the estimation unit 32. Based on a feature of each audio frame segmented from a speech (supplied by the acquisition unit 10) at a predetermined interval, the estimation unit 32 identifies an audio component included in the audio frame (S901). Here, as the audio component identified by the estimation unit 32, a specific sound such as a clapping of hands or a jingle co-occurred at a scene boundary is utilized.

The estimation unit 32 compares each audio component between adjacent audio frames, and estimates a scene thereof (S902). For example, the estimation unit 32 estimates a scene boundary from an image frame corresponding to an audio frame from which a specific sound (such as a clapping of hands or a jingle) co-occurred thereat is detected.

In order to raise accuracy to identify the audio component, a component of the environmental sound supplied by the separation unit 22 may be targeted. Furthermore, in order to avoid fluctuation of decision due to an audio component suddenly inserted, a shot prescribed by cut detection (as explained in the first embodiment) may be a unit of decision.

In the example of FIG. 13, a scene boundary is decided by a clapping sound of hands appeared just before an image frame f30 to begin playing of a musical piece. As a result, the scene boundary is estimated to be between two image frames f29 and f30, and two scenes D and E are estimated.

Moreover, in this example, the estimation unit 32 estimates the scene boundary from a specific sound. However, by analyzing the image frame, the scene boundary may be estimated from appearance of title-telop and so on. Thus far, processing of the estimation unit 32 is explained.

FIG. 17 is a flow chart of processing of the analysis unit 42. From an image frame to be processed in a moving image (supplied by the acquisition unit 10), the analysis unit 42 generates at least one reduction image of which sizes are different (S1001).

The analysis unit 42 sets a search region into each reduction image, calculates a feature of the search region, and decides whether the search region includes a face region of a person by comparing the feature with templates (S1002).

As to the face region detected, from a feature co-occurred at both the face region and a circumference region thereof, the analysis unit 42 decides whether a musical instrument region is included by comparing with a dictionary previously stored (S1003). Here, as the musical instrument, in addition to objects of typical musical instruments such as percussion or string instrument, a microphone held by a vocalist may be trained and preserved. From the musical instrument region, the analysis unit 42 acquires attribute information such as a type of the musical instrument, the number of musical instruments, and a position thereof (S1004). Thus far, processing of the analysis unit 42 is explained.

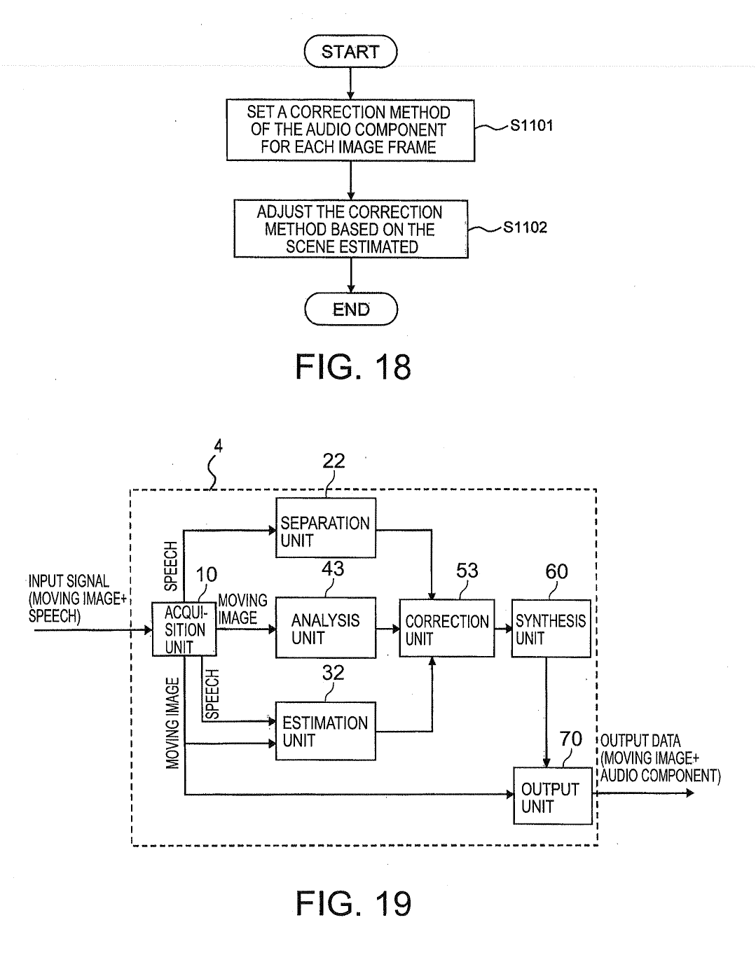

FIG. 18 is a flowchart of processing of the correction unit 52. Based on the attribute information acquired by the analysis unit 42, the correction unit 52 sets a correction method of an audio component corresponding to each image frame in the moving image (S1101). In this example, the attribute information is the number of musical instruments, a type of the musical instrument, and a position thereof.

For example, the correction unit 52 sets the correction method such as (1) When the musical instrument region is detected, an audio component of the musical instrument is corrected so that a sound of the musical instrument is output from a position thereof, and (2) In BGM segment not including the musical instrument, all of the music piece is corrected by surround processing.

In the example of FIG. 13, the analysis unit 42 detects musical instrumental regions from image frames f30˜f35, and does not detect the musical instrumental regions from an image frame f36.

As to a scene estimated by the estimation unit 32, the correction unit 52 adjusts the correction method of each image frame (S1102). Briefly, as to two scenes D and E estimated by the estimation unit 32, the correction unit 52 decides whether to change the correction method set to each image frame.

For example, in the moving image of FIG. 13, musical instruments are not detected from image frames f26˜f29 of scene D, and musical instruments are detected from image frames f30˜f35 of scene E. Furthermore, musical instruments are not detected from an image frame f36 of scene E.

At S1101, the correction method of above-mentioned (2) is set to an audio component corresponding to the image frame f36 of scene E. Furthermore, the correction method of above-mentioned (1) is set to audio components corresponding to image frames f30˜f35 of scene D.

At S1102, as to audio components corresponding to image frames included in one scene, the correction unit 52 adjusts the correction method so that the same correction method is set to the image frames. Here, among correction methods set to image frames included in one scene, the correction unit 52 selects one correction method corresponding to the largest number of image frames included in the one scene, and adjusts another correction method corresponding to image frames except for the largest number of image frames included in the one scene.

In FIG. 13, among image frames included in the scene E, the correction method (2) is already set to one image frame f36, and the correction method (1) is already set to six image frames f30˜f35.

Accordingly, the correction unit 52 changes the correction method (2) of audio components of the image component f36 to the correction method (1). Briefly, the correction unit 52 adjusts the correction method so that the same correction method is set to audio components of all image frames included in the scene E.

As to audio components corresponding to image frames included in the scene D, the correction method (2) is already set thereto. Thus, processing of the correction unit 52 is explained.

In the third embodiment, as to image frames from which musical instruments are not detected, the same correction method as other image frames in one scene including the image frames is applied by supplementing from the other image frames. As a result, stable correction of audio components can be performed without fluctuating correction methods.

### The Fourth Embodiment

In an audio correction apparatus 4 of the fourth embodiment, in comparison with the third embodiment, following two points are different. First, a motion of a camera (camera-work) is analyzed from a moving image. Second, audio components are corrected based on the camera-work.

FIG. 19 is a block diagram of the audio correction apparatus 4. In the audio correction apparatus 4 compared with the audio correction apparatus 3, the analysis unit 40 is replaced with an analysis unit 43, and the correction unit 50 is replaced with a correction unit 53.

The analysis unit 43 analyzes a speech or a moving image (supplied from the acquisition unit 10), and acquires attribute information. The attribute information is camera-work information such as zoom, pan, zoom-in and zoom-out in a scene. The analysis unit 43 may detect a motion of an object appearing in each frame of the scene, and acquire the camera-work information.

For example, the analysis unit 43 segments each image frame of the moving image (supplied from the acquisition unit 10) into a plurality of blocks each having pixels. Between two image frames temporally adjacent, the analysis unit 43 calculates a motion vector by matching a block of one of the two image frames with a corresponding block of the other thereof. As this block matching, a template matching by scale of similarity such as SAD (Sum of Absolute Difference) or SSD (Sum of Squared Difference) is used.

The analysis unit 43 calculates a histogram of the motion vector of each block among image frames. When many motion vectors along a fixed direction are detected, the analysis unit 43 estimates a camera-work (including pan and tilt) such as movement along up and down, and along right and left. Furthermore, when a distribution of the histogram is large and a spoke-like motion vector distributes toward the outside, the analysis unit 43 estimates a camera-work of zoom-in. On the other hand, when a distribution of the histogram is large and a spoke-like motion vector distributes toward the inside, the analysis unit 43 estimates a camera-work of zoom-out. Moreover, a method for detecting the camera-work is not limited to above-mentioned method.

Based on camera-work information acquired by the analysis unit 43, the correction unit 53 sets a correction method to an audio component corresponding to each image frame in the scene, and corrects a position to occur the audio component to be outputted (For example, the audio component is loudly heard from the right side). Based on a scene boundary, the correction unit 53 determines an image frame to set the correction method. The analysis unit 43 and the correction unit 53 may be realized by a CPU and a memory used thereby.

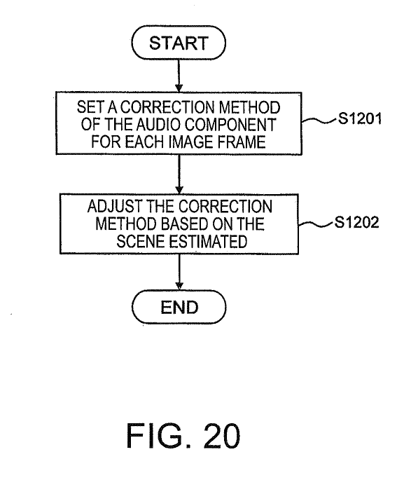

FIG. 20 is a flow chart of processing of the correction unit 53. Based on camera-work information (attribute information) analytically acquired by the analysis unit 53, the correction unit 53 sets a correction method (S1201). In the fourth embodiment, the correction unit 53 sets the correction method as following three cases. (1) When zoom-in or zoom-out is detected, the correction method is set so that a volume is increased or reduced based on a motion vector thereof. (2) When pan or tilt is detected, a position to occur the audio component is moved based on a motion vector thereof. (3) When the camera-work is not detected, the correction method is set so as not to correct.

In the example of FIG. 13, the analysis unit 43 detects zoom-out from image frames f30˜f35, and detects a camera-work that moves to the right side from image frames f34˜f36.

As to two scenes D and E estimated by the estimation unit 32, the correction unit 53 decides whether to change the correction method set to each image frame (S1202).

In FIG. 13, among image frames included in the scene E, the correction method (2) is already set to two image frames f35˜f36, and the correction method (1) is already set to five image frames f30˜f34.

Accordingly, the correction unit 53 changes the correction method (2) of audio components of two image components f35˜f36 to the correction method (1). Briefly, the correction unit 53 adjusts the correction method so that the same correction method is set to audio components of all image frames included in the scene E.

As to audio components corresponding to image frames included in the scene D, the correction method (3) is already set thereto.

In the fourth embodiment, by comparing camera-works of all image frames included in the same scene (scene E), the correction unit 53 corrects audio components so as to preferentially follow a camera-work of which image frames are relatively many among all frames. Thus, processing of the correction unit 53 is explained.

In the fourth embodiment, as to audio components corresponding to image frames estimated as the same scene, the same correction method is applied by using camera-work information. As a result, stable audio correction can be performed without fluctuation of the correction method thereof.

As mentioned-above, in the first, second, third and fourth embodiments, a speech corresponding to a moving image can be corrected as a speech easy for a viewer to hear.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for correcting a speech corresponding to a moving image, comprising:
a separation unit configured to separate at least one audio component from each audio frame of the speech;
an estimation unit configured to estimate a scene including a plurality of image frames related in the moving image, based on at least one of a feature of each image frame of the moving image and a feature of the each audio frame;
an analysis unit configured to acquire attribute information of the plurality of image frames by analyzing the each image frame; and
a correction unit configured to determine a correction method of the audio component corresponding to the plurality of image frames, based on the attribute information, and correct the audio component by the correction method.

2. The apparatus according to claim 1, wherein
the estimation unit detects each cut boundary in the moving image based on the feature of the each image frame, and estimates the scene, based on the feature of image frames included between a cut boundary and another cut boundary detected just before the cut boundary.

3. The apparatus according to claim 2, wherein
the analysis unit acquires the attribute information representing whether the each image frame includes at least one person region, and
the correction unit compares the number of image frames including the person region with the number of image frames not including the person region in the plurality of image frames, and determines the correction method based on the comparison result.

4. The apparatus according to claim 3, wherein
the correction unit corrects the audio component by the correction method corresponding to the larger number of image frames in the comparison result.

5. The apparatus according to claim 1, wherein
the estimation unit clusters a type of the audio component included in the each audio frame, and estimates the scene based on the type.

6. The apparatus according to claim 1, wherein
the estimation unit estimates the scene by deciding whether to detect a specific sound from the each audio frame.

7. A method for correcting a speech corresponding to a moving image, comprising:
separating at least one audio component from each audio frame of the speech;
estimating a scene including a plurality of image frames related in the moving image, based on at least one of a feature of each image frame of the moving image and a feature of the each audio frame;
acquiring attribute information of the plurality of image frames by analyzing the each image frame;
determining a correction method of the audio component corresponding to the plurality of image frames, based on the attribute information; and
correcting the audio component by the correction method.

8. A non-transitory computer readable medium for causing a computer to perform a method for correcting a speech corresponding to a moving image, the method comprising:
separating at least one audio component from each audio frame of the speech;
estimating a scene including a plurality of image frames related in the moving image, based on at least one of a feature of each image frame of the moving image and a feature of the each audio frame;
acquiring attribute information of the plurality of image frames by analyzing the each image frame;
determining a correction method of the audio component corresponding to the plurality of image frames, based on the attribute information; and
correcting the audio component by the correction method.
